(19) United States
(12) Patent Application Publication
(10) Pub. No.: US 2016/0249711 A1
(43) Pub. Date: Sep. 1, 2016

(54) Paper Chain Template

(71) Applicant: Ward C. Smith, Quincy, MA (US)

(72) Inventor: Ward C. Smith, Quincy, MA (US)

(21) Appl. No.: 14/634,846

(22) Filed: Mar. 1, 2015

(51) Int. Cl. A44C 5/00; B26F 1/38

(52) U.S. Cl. CPC A44C 5/0053; B26F 1/38

(57) ABSTRACT

Paper chains have been used by children to make paper jewelry for a century. Decorative patches have been worn throughout history, offering feelings of pride and belonging. My invention consists of at least one computer template that controls the printing of decorative patches on supply paper for paper chain making. Paper chains present two visible sides made up of sets of 2 (half) one-half inch squares. The intent is to increase the visual impact by maximizing the size of decorative patches. The template prints only on those squares that are visible when the paper chain is assembled, reducing printing ink by as much as seventy five percent. The template addresses design problems characteristic of assembly of paper chains. The template eliminates decoration misalignment due to the chain link assembly procedure, and eliminates asymmetry errors due to view reversal that results from the folding of paper chain links.

### BACKGROUND

Paper chain making is a century old craft process for hand folding scrap paper rectangles into interlocking paper chains. This process was used by children to make paper chain jewelry. The TV, computer, and I phone have all but eliminated paper chain making. However, those advances have also made available opportunities for renewing paper chain making. Of particular importance is an economy with a standard of living that allows purchase of quality papers for paper jewelry making. With computers and color printers, the craft of paper chain making can add personalized designs to enhance jewelry. Paper chain making might now move from the used/scrap paper of its past, to the new colors, textures, weights, and decorated papers now available.

A typical paper chain link is about one inch long and a half inch wide. It is folded into an interlocking chain link from a cut paper rectangle that is roughly one inch by four inches, twenty two 2-ply links from an 8.5 by 11 inch sheet of paper. The two sides of a paper chain link provide two visible surfaces. Because the chain links are assembled at 90 degrees to each other, the two half by one inch rectangular surfaces of the link become defined, with each a one inch surface made up half from a first link and half from the following link. Since there is only one direction in which to insert links, patterns in these half inch squares rotate ninety degrees, back and forth, from link to link.

For fully decorated supply sheets, the patterns must be very small to present well on a paper chain. This tends to reduces the paper chain attraction to the pleasure of creating something physical and a general sense of artistic appeal. Supply sheets with a hill sheet random design of small paw prints were selected to make paper chain bracelets for sale at a church fair. They sold out immediately to a group of adults who volunteer at a pet rescue facility. It seems obvious that paper chain designs that elicit feelings of belonging and self-esteem have strong appeal. Unexpected was the number of adults pleased to wear a variety of paper chain bracelets, both because of their uniqueness and because of the quality of papers used. This suggests the possibility of an adult market. Based on these insights, a project was begun to choose existing designs that offer this emotional appeal. They range from scout badges, to regimental patches, to signatures, etc. To make these decorations highly visible, computer templates were invented to maximize the size and positioning of patch decorations to be within the half inch square visible surfaces on the paper chains. With a paper chain crease block and 2-ply chain capability, it is now possible to fold the a broad range of paper weights, hardness and textures. The intent is to increase the utility of paper chain jewelry to a level that packets of cut paper rectangles become the razor blade to the crease block razor. This would require adding supply sheets of emotive patch decorations to supplement colored supply sheets and full design supply sheets. The printing of aligned symmetrical and asymmetrical patches on supply sheets for paper chains brought creative challenges.

### A BRIEF DESCRIPTION OF THE INVENTION

The objective of my invention is to create paper chain jewelry with an appeal to the wearer's need for belonging and for self esteem. This requires patch decorations large enough to be recognizable at a distance typical of social interactions. My invention includes at least one computer template that controls placement of specifically sized, individual decorations (patches) within the visible surfaces of assembled chains. Each decoration must then fit inside a half inch square on a paper rectangle cut from a supply sheet. For a 2-ply paper chain and using an 8.5 by 11 inch supply sheets of paper as a source for 4.25 by 1.00 inch rectangles, the sheet is cut lengthwise in half and then each half cut into approximately inch strips. This produces 22 cut paper rectangles per sheet, enough for one bracelet per sheet. The traditional 4-ply paper chain would have the same design format on the outer segments of the cut rectangle when folded into a paper chain link, but producing only 14 paper rectangles per sheet. The strength attributed to 4-ply chains can be offset by 2-ply chains with available heavier weight papers. Using approximately the same cut rectangle width to length ratios, it becomes obvious that this invention can apply to other supply sheet cutting strategies.

Selected decorative designs are the typical emblems and patches that are worn to show belonging and personal accomplishment. They are medals, regimental patches, personal initials, scout badges, sorority and fraternity Greek characters, school emblems, and a variety of patches related to current children's stories and movies such as smiles, skulls, sabers, and characters. These patches can be used singly or in repeating groups. Colored sheets of paper can be used that enhanced the colors in the decorative patches. The variety of shapes and the decorations represented require a specific supply sheet template to align and orient adjacent decorations. The method of folding and the assembly of paper chains present a second problem that is addressed by the template. The use of The Paper Chain Factory Toy crease block (patent application Ser. No. 14/482,169) offers defined locations of crease lines and thus more accurate placement of patch designs. Reducing folding to a single crease line (2-ply) from the three crease lines (4-ply) also facilitates accurate placement of decorations.

### A BRIEF REVIEW OF DRAWINGS

Drawing No. 1 shows the steps in the process of making a 2-ply paper chain. FIG. 1 shows a cut paper rectangle having been creased by a Paper Chain Factory crease block. The rectangle is folded by hand at the crease line to obtain a strip. FIG. 2 shows the paper strip with crease line locations. The strip center crease is made by hand by placing the two ends together. This method is faster and more accurate by hand than by using a stop gauge to position the crease. FIG. 3 shows the creased strip folded along the three, crease lines. The outer creases are made with a crease block to control segment lengths and the positioning of patch decorations. FIG. 4 shows the initial six links of a paper chain with the pattern of visual square surfaces.

Drawing No. 2 shows the position of crease lines and positioning of decorations. FIG. 1 shows the format of horizontal and vertical crease lines on a cut paper rectangle. FIG. 2 shows the format and positioning of decorations on a cut paper rectangle for use in a paper chain with decoration on both sides. Note that the mirror image decorations have been removed as they are not visible after folding. FIG. 3 shows the format and positioning of the decoration on a cut rectangle for use in a paper chain with decoration only on the outside of the bracelet. The inside of a bracelet is not visible when worn.

Drawing No. 3 shows the decorations after folding and assembling paper chain links. FIG. 1 shows a paper chain link having decoration on both sides of a paper chain. FIG. 2 shows a paper chain link having decoration on one side of a paper chain. FIG. 3 shows the pattern of decorations on one side of the initial assembly of a paper chain.

Drawing No. 4 shows the changing orientation of the decorations from one link to the next, resulting from the insertion of each link at 90 degrees to the previous link. By rotating the decoration 90 degrees on the cut rectangle of every other link, the decoration aligns and appears without the 90 degree wobble.

FIG. 1 shows the normal assembly with changing orientation.

FIG. 2 shows an aligned assembly that removes the periodic rotation of the decorations.

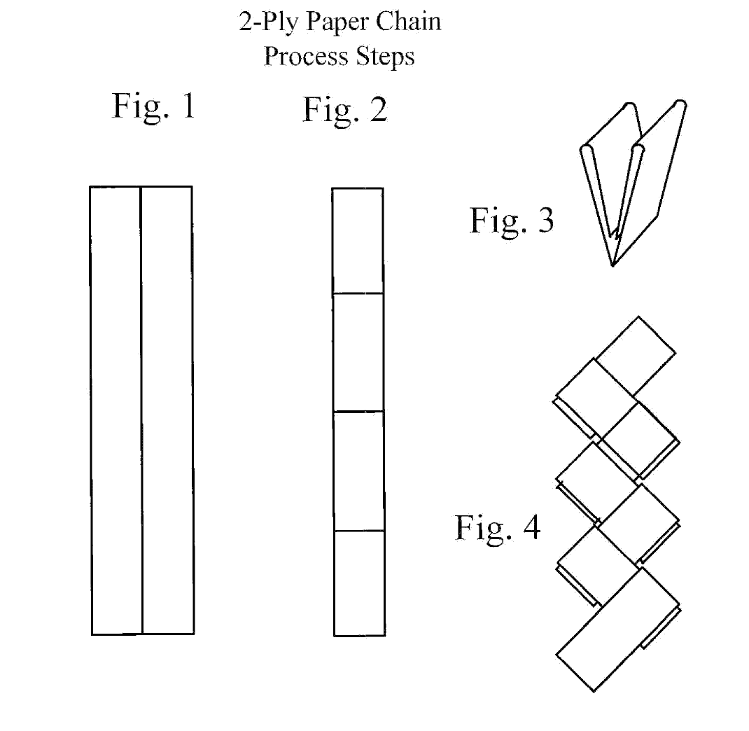

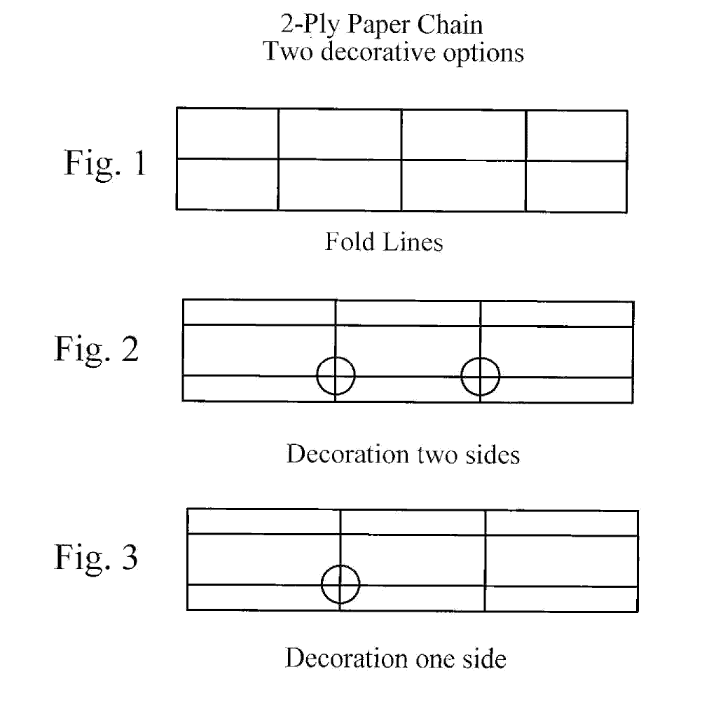

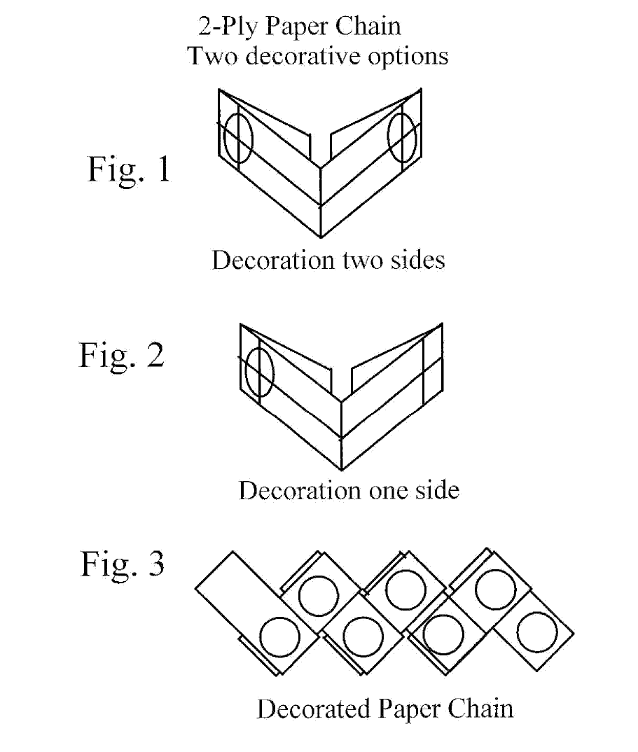

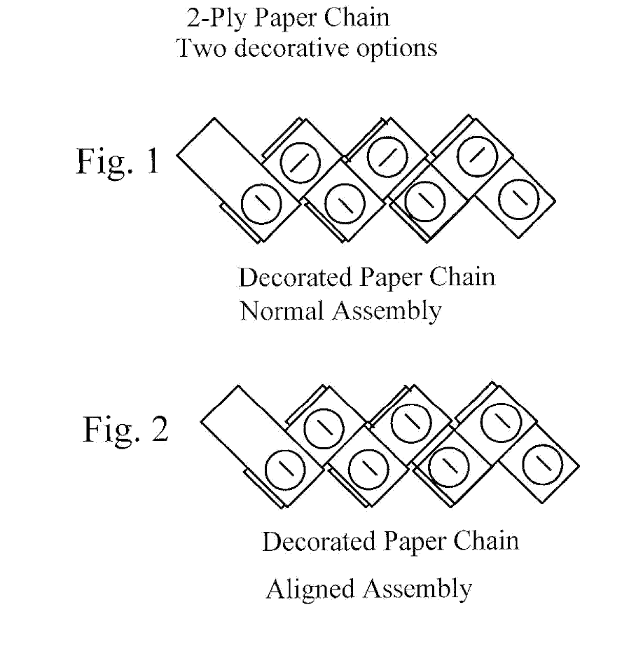

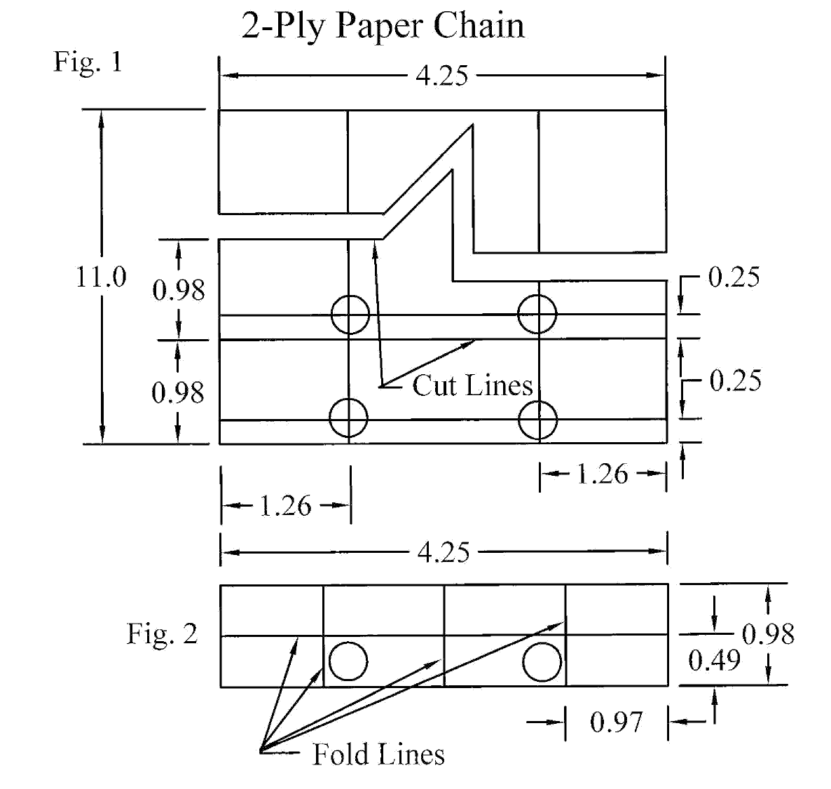

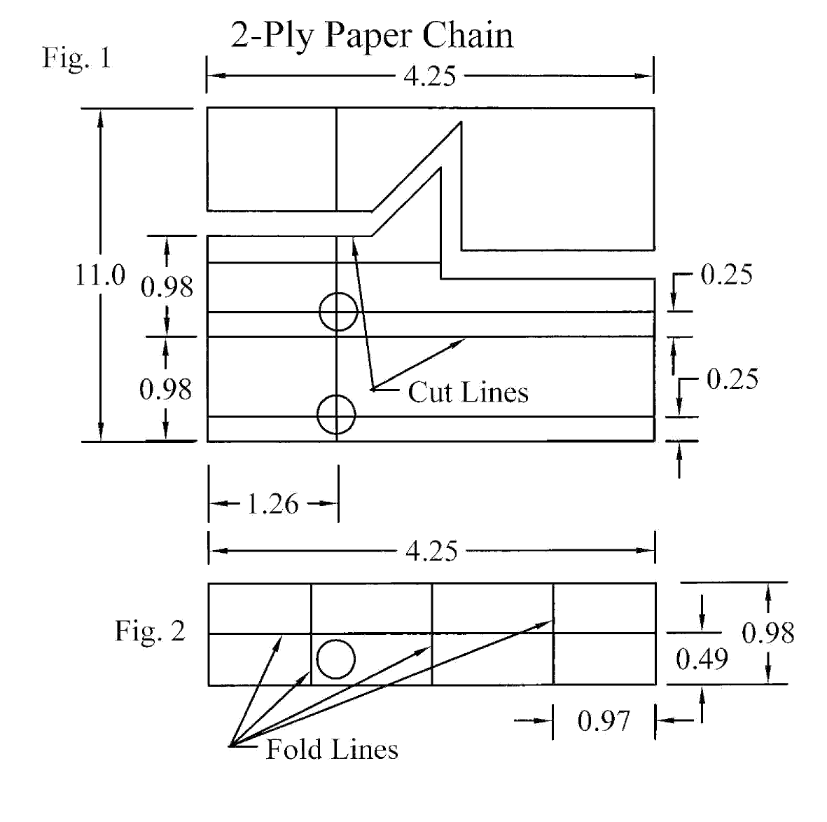

Drawing No. 5 shows a template for positioning paper chain decorations on 8.5×11 inch sheets of paper. The paper sheet is cut in half lengthwise to make two half sheets, each containing 11 cut paper rectangles. One such half sheet is shown with the template defined. A page break is required to fit the drawing on a single page. The chain forms a bracelet with decoration on both sides. FIG. 1 shows the template. FIG. 2 shows a cut paper rectangle with the orientation of the decoration.

Drawing No. 6 shows a template for a paper chain bracelet having one side decorated. This template allows reduction in ink, but also eliminates view reversal due to folding of the link. FIG. 1 shows the template. FIG. 2 shows a cut paper rectangle with the orientation of the decoration on only one side.

### A DETAILED DESCRIPTION OF THE INVENTION

Initial assembly and disassembly of several chain links show which link surfaces are visible after assembly. The initial experience was to have paper rectangles cut from a decorated sheet, having decoration on both sides of the paper chain. This was followed by having four patch decorations on each paper rectangle, presented as a mirror image pattern of paired decorations when folded. The lengthwise fold would place the decorations super imposed on the front and back side of the folded rectangle strip. However, when the strip is folded into a chain link it becomes clear that only two of the four decorations are visible. They are close to the insertion ends of the link, one on each side. The decorations on these legs of the link are passed through the previously assembled link and are visible after assembly. The resulting chain becomes a series of pairs of two decorations, one decoration on each of two adjacent links. This pairing repeats along the chain, and is true of both sides of the chain.

Examining the link, it can be seen that the orientation of the link is essential for insertion. One side of the link has one clear passage through each leg for insertion. The opposite side has one clear passage and two cul-de-sacs. From this side there are two chances in three of insertion failure on each leg. There is only one correct side of the link for insertion of the next link, and one correct side, held downward, in holding the link for insertion.

Paper chain links are assembled with each link inserted at 90 degrees to the previous link. The pattern then rotates back and forth at 90 degrees with each insertion. The template, by controlling printing of the decorations in the same rotation pattern on the supply sheet, allows the decorations on the assembled chain to occur without rotation. This process offers a consistency that is visually pleasing. It also makes possible a one half by one inch pattern made up of two half-designs mating at the center. This suggests connected designs such as ‘Lov|You’, half in each of two aligned squares. Emotional appeal is the objective of these paper chain designs.

The printed decorations, after 90 degree rotation, are a mirror image of each other on each rectangle. Since the second printed pair is rotated 90 degrees on either side of the central fold of the cut rectangle, the left decoration is rotated negative 90 degrees and the right decoration is rotated positive 90 degrees, making the mirror image.

If a decoration has both orthogonal and polar symmetry, there is no observable folding problems from link to link. However, if the decorations on a link with 90 degree rotation are asymmetrical, such as a shield with a specific color in the upper left quadrant, that color will appear in the upper right quadrant on the opposite side of the link. This view reversal is due to center folding the strip. The template eliminates this view reversal problem by placing that specific color on the upper left quadrant on the left end of the cut rectangle and on the upper right quadrant on the right end of the cut rectangle. Seen from either side of the link, the specific color appears correctly in the upper left quadrant of the shield. This is equivalent to replacing the patch decoration on the right of the cut rectangle with its mirror image, based on a horizontal image line.

The issue came up of whether a bracelet needs decoration on both sides. When worn, the inside of the bracelet is not visible. For a bracelet decorated only on the one side, the cut paper rectangle has a patch decoration only on its left side. This reduces the ink required in half again, making the total reduction seventy five percent. Coincidently, a bracelet with only one side decorated has no view reversal. No asymmetry problem exists for this design option

Many patterns have a length greater than its width. The template allows positioning of patches on the supply sheets that centers each patch in its respective square.

Each supply sheet for two-ply paper chains is cut in half, each half yielding 11 cut paper rectangles. This involves ten cuts per half sheet. Rapid cutting of supply sheets usually involves a stop gauge for cut paper rectangles. An error of 0.010 inch is hardly visible, but in a cutting setup that error multiplies by ten, eliminating two paper rectangles per sheet. To avoid this summing of setup error, the template provides for cut lines on the supply sheets.

A supply sheet cut vertically into three parts, yields 51 cut rectangles with 16 cuts from each part, increasing the need for cut lines. This reduces the size of the squares by 30%, requiring greater precision in cutting and printing. The use of 8.5 by 11 inch supply sheets to describe my invention is not intended to limit the application to specific sizes of cut rectangles or of supply sheets of paper.

1. I claim at least one design template that controls the printing of patch designs on supply sheets from which paper (cut) rectangles are cut and (are) folded into paper chains.

2. I claim a design template according to claim 1 that aligns (of) patch designs on at least one side of the links in a paper chain.

3. I claim a design template according to claims 1 and 2 that corrects the printing of asymmetrical design patterns on paper chains by compensating for view reversal due to folding.

4. I claim a design template that provides cut lines on supply sheets for cutting of paper chain rectangles from said supply sheets, avoiding the summing of setup cutting errors.

5. I claim a process for making paper chain bracelets water resistant, more durable, and easy to clean by applying and drying a liquid coating.

6. I claim a liquid coating according to claim 5 that is polyurethane.
